(19) United States
(12) Patent Application Publication
(10) Pub. No.: US 2025/0310522 A1
(43) Pub. Date: Oct. 2, 2025

(54) QUANTIZING OVERFITTED FILTERS

(71) Applicant: Nokia Technologies Oy, Espoo (FI)

(72) Inventors: Ruiying YANG, Tampere (FI); Miska Matias HANNUKSELA, Tampere (FI); Maria Claudia SANTAMARIA GOMEZ, Tampere (FI); Francesco CRICRÌ, Tampere (FI)

(21) Appl. No.: 19/085,140

(22) Filed: Mar. 20, 2025

Related U.S. Application Data
(60) Provisional application No. 63/570,523, filed on Mar. 27, 2024.

(51) Int. Cl. H04N 19/117; H04N 19/124; H04N 19/70; H04N 19/82

(52) U.S. Cl. CPC H04N 19/117; H04N 19/124; H04N 19/70; H04N 19/82

(57) ABSTRACT

Various embodiments provide methods, apparatuses, and computer program products. An apparatus includes: at least one processor; and at least one memory storing instructions that, when executed by the at least one processor, cause the apparatus at least to perform: determining an updated neural network filter based at least on a base or pretrained NN filter and on an update; and quantizing the updated NN filter by using one or more quantization parameters (QPs).

### TECHNICAL FIELD

The examples and non-limiting embodiments relate generally to neural networks and, more particularly to, quantizing overfitted filters.

### BACKGROUND

It is known to use neural networks for media data processing.

### SUMMARY

Example 1: An apparatus comprising: at least one processor; and at least one memory storing instructions that, when executed by the at least one processor, cause the apparatus at least to perform: determining an updated neural network filter based at least on a base or pretrained neural network (NN) filter and on an update; and quantizing the updated NN filter by using one or more quantization parameters (QPs).

Example 2: The apparatus of example 1, wherein at least another one QP of the one or more QPs is predetermined in an offline phase to generate at least one predetermined QP, and wherein the at least one predetermined QP is available at the apparatus.

Example 3: The apparatus of example 2, wherein the at least one predetermined QP is same or substantially same as a QP used to quantize the base or the pretrained NN filter.

Example 4: The apparatus of any of the previous examples, wherein the updated NN filter uses same quantizers and internals as the quantizers and internals used to quantize the base or pretrained NN filter, and wherein a quantizer is used to quantize a parameter of a NN, and wherein an internal is used to quantize an input, an intermediate input, an output, or an intermediate output of the NN.

Example 5: The apparatus of example 2, wherein the at least one predetermined QP is predetermined based on one or more other updated NN filters, and wherein the one or more other updated NN filters are updated during the offline phase.

Example 6: The apparatus of example 1, wherein the updated NN filter is quantized based on data-driven quantization to obtain respective one or more sets of QPs.

Example 7: The apparatus of example 6, wherein the respective one or more sets of QPs comprise one or more of the following: respective one or more quantizers for convolutional kernel layers; respective one or more internals for the convolutional kernel layers; respective one or more quantizers for bias layers; respective one or more internals for the bias layers; respective one or more quantizers for multiplier layers; or respective one or more internals for the multiplier layers.

Example 8: The apparatus of example 7, wherein the apparatus is further caused to perform: combining the one or more sets of QPs to obtain a single set of QPs.

Example 9: The apparatus of example 8, wherein: the one or more quantizers for the convolutional kernel layers of respective one or more updated NN filters are combined into a single quantizer for the convolutional kernel layers; the one or more internals for the convolutional kernel layers of the respective one or more updated NN filters are combined into a single internal for the convolutional kernel layers; the one or more quantizers for the bias layers of respective one or more updated NN filters are combined into a single quantizer for the bias layers; the one or more internals for the bias layers of the respective one or more updated NN filters are combined into a single internal for the bias layers; the one or more quantizers for the multiplier layers of the respective one or more updated NN filters are combined into a single quantizer for the multiplier layers; and the one or more internals for the multiplier layers of the respective one or more updated NN filters are combined into a single internal for the multiplier layers.

Example 10: The apparatus of any of the examples 8 or 9, wherein the one or more QPs comprise the single set of QPs.

Example 11: The apparatus of example 1, wherein the apparatus is caused to perform: receiving, in or along a bitstream, at least one QP of the one or more QPs from an encoder.

Example 12: The apparatus of example 11, wherein the at least one QP is carried within an adaptation parameter set (APS) that is associated with an update to the base or pretrained NN filter or with the updated NN filter.

Example 13: The apparatus of example 11, wherein the at least one QP is carried within a supplemental enhancement information (SEI) message that is associated with an update to the base or pretrained NN filter or with the updated NN filter.

Example 14: The apparatus of example 1, wherein the apparatus comprises a set of predetermined QPs, and wherein the apparatus is caused to perform: receiving an indication, one or more QPs, and/or one or more QP updates, wherein the one or more QPs replace respective one or more predetermined QPs in the set of predetermined QPs, and wherein the one or more QP updates are used to update respective one or more predetermined QPs in the set of predetermined QPs based on an update rule that is predefined or based on the indication.

Example 15: The apparatus of example 14, wherein the apparatus comprises a predetermined quantizer and a predetermined internal for convolutional kernel layers, a predetermined quantizer and a predetermined internal for bias layers, a predetermined quantizer and a predetermined internal for multiplier layers.

Example 16: The apparatus of example 15, wherein the apparatus is further caused to perform: receiving an adaptation parameter set (APS) comprising: an update to the base or pretrained NN filter; an update to the predetermined quantizer for the convolutional kernel layers; an update to the predetermined internal for the convolutional kernel layers; an update to the predetermined internal for the multiplier layers; an updated quantizer for the multiplier layers; an update to the predetermined quantizer for the bias layers; or an update to the predetermined internal for the bias layers.

Example 17: The apparatus of example 14, wherein the apparatus comprises: one or more predetermined QPs for convolutional kernel layers, wherein a first one or more convolutional kernel layers of the convolutional kernel layers use a same QP and a second one or more convolutional kernel layers of the convolutional kernel layers use different QPs; one or more predetermined QPs for bias layers; and one or more predetermined QPs for multiplier layers.

Example 18: The apparatus of example 17, wherein the apparatus is further caused to perform: receiving an adaptation parameter set (APS) comprising: an update to the base or pretrained NN filter; one or more updates to one or more predetermined quantizers for the convolutional kernel layers; one or more updates to one or more predetermined internals for the convolutional kernel layers; one or more updates to one or more predetermined internals for the multiplier layers; one or more updates to one or more predetermined quantizers for the bias layers; one or more updates to one or more predetermined internals for the bias layers; or one or more updated quantizers for the multiplier layers.

Example 19: An apparatus comprising: at least one processor; and at least one memory storing instructions that, when executed by the at least one processor, cause the apparatus at least to perform: signaling, in or along a bitstream, an update to a decoder; signaling, in or along the bitstream, at least one quantization parameters (QP) of one or more QPs to the decoder; and wherein the one or more QPs are used to quantize an updated neural network (NN) filter, and wherein the updated NN filter is based at least on a base or pretrained NN filter and on the update.

Example 20: The apparatus of example 19, wherein at least another one QP of the one or more QPs is predetermined in an offline phase to generate at least one predetermined QP, and wherein the at least one predetermined QP is available at the decoder.

Example 21: The apparatus of example 20, wherein the at least one predetermined QP is same or substantially same as a QP used to quantize the base or the pretrained NN filter.

Example 22: The apparatus of any of the examples 19 to 21, wherein the updated NN filter uses same quantizers and internals as the quantizers and internals used to quantize the base or pretrained NN filter, and wherein a quantizer is used to quantize a parameter of a NN, and wherein an internal is used to quantize an input, an intermediate input, an output, or an intermediate output of the NN.

Example 23: The apparatus of example 20, wherein the at least one predetermined QP is predetermined based on one or more other updated NN filters, and wherein the one or more other updated NN filters are updated during the offline phase.

Example 24: The apparatus of example 19, wherein the updated NN filter is quantized based on data-driven quantization to obtain respective one or more sets of QPs.

Example 25: The apparatus of example 24, wherein the respective one or more sets of QPs comprise one or more of the following: respective one or more quantizers for convolutional kernel layers; respective one or more internals for the convolutional kernel layers; respective one or more quantizers for bias layers; respective one or more internals for the bias layers; respective one or more quantizers for multiplier layers; or respective one or more internals for the multiplier layers.

Example 26: The apparatus of example 25, the one or more sets of QPs are combined to obtain a single set of QPs.

Example 27: The apparatus of example 26, wherein: the one or more quantizers for the convolutional kernel layers of respective one or more updated NN filters are combined into a single quantizer for the convolutional kernel layers; the one or more internals for the convolutional kernel layers of the respective one or more updated NN filters are combined into a single internal for the convolutional kernel layers; the one or more quantizers for the bias layers of respective one or more updated NN filters are combined into a single quantizer for the bias layers; the one or more internals for the bias layers of the respective one or more updated NN filters are combined into a single internal for the bias layers; the one or more quantizers for the multiplier layers of the respective one or more updated NN filters are combined into a single quantizer for the multiplier layers; and the one or more internals for the multiplier layers of the respective one or more updated NN filters are combined into a single internal for the multiplier layers.

Example 28: The apparatus of any of the examples 26 or 27, wherein the one or more QPs comprise the single set of QPs.

Example 29: The apparatus of example 19, wherein the apparatus is caused to perform: signaling, in or along the bitstream, at least one QP of the one or more QPs to the decoder.

Example 30: The apparatus of example 29, wherein the at least one QP is carried or signaled within an adaptation parameter set (APS) that is associated with an update to the base or pretrained NN filter or with the updated NN filter.

Example 31: The apparatus of example 29, wherein the at least one QP is carried or signaled within a supplemental enhancement information (SEI) message that is associated with an update to the base or pretrained NN filter or with the updated NN filter.

Example 32: The apparatus of example 19, wherein the apparatus is further caused to perform: signaling an indication, one or more QPs, and/or one or more QP updates associated to respective one or more predetermined QPs comprised in the decoder, wherein the one or more QPs replace the respective one or more predetermined QPs, and wherein the one or more QP updates are intended to be used to update the respective one or more predetermined QPs based on an update rule that is predefined or based on the indication.

Example 33: The apparatus of example 32, wherein the apparatus is further caused to perform: signaling an adaptation parameter set (APS) comprising: an update to the base or pretrained NN filter; an update to the predetermined quantizer for convolutional kernel layers comprised at the decoder; an update to the predetermined internal for the convolutional kernel layers comprised at the decoder; an update to the predetermined internal for multiplier layers comprised at the decoder; an updated quantizer for the multiplier layers comprised at the decoder; an update to the predetermined quantizer for bias layers comprised at the decoder; or an update to the predetermined internal for the bias layers comprised at the decoder.

Example 34: The apparatus of example 32, wherein the apparatus is further caused to perform: signaling an adaptation parameter set (APS) comprising following to the decoder: an update to the base or pretrained NN filter; one or more updates to one or more predetermined quantizers for convolutional kernel layers; one or more updates to one or more predetermined internals for the convolutional kernel layers; one or more updates to one or more predetermined internals for multiplier layers; one or more updates to one or more predetermined quantizers for bias layers; one or more updates to one or more predetermined internals for the bias layers; or one or more updated quantizers for the multiplier layers.

Example 35: A method comprising: determining an updated neural network filter based at least on a base or pretrained neural network (NN) filter and on an update; and quantizing the updated NN filter by using one or more quantization parameters (QPs).

Example 36: The method of example 35, wherein at least another one QP of the one or more QPs is predetermined in an offline phase to generate at least one predetermined QP, and wherein the at least one predetermined QP is available at a decoder.

Example 37: The method of example 36, wherein the at least one predetermined QP is same or substantially same as a QP used to quantize the base or the pretrained NN filter.

Example 38: The method of any of the examples 35 to 37, wherein the updated NN filter uses same quantizers and internals as the quantizers and internals used to quantize the base or pretrained NN filter, and wherein a quantizer is used to quantize a parameter of a NN, and wherein an internal is used to quantize an input, an intermediate input, an output, or an intermediate output of the NN.

Example 39: The method of example 36, wherein the at least one predetermined QP is predetermined based on one or more other updated NN filters, and wherein the one or more other updated NN filters are updated during the offline phase.

Example 40: The method of example 35, wherein the updated NN filter is quantized based on data-driven quantization to obtain respective one or more sets of QPs.

Example 41: The method of example 40, wherein the respective one or more sets of QPs comprise one or more of the following: respective one or more quantizers for convolutional kernel layers; respective one or more internals for the convolutional kernel layers; respective one or more quantizers for bias layers; respective one or more internals for the bias layers; respective one or more quantizers for multiplier layers; or respective one or more internals for the multiplier layers.

Example 42: The method of example 41 further comprising combining the one or more sets of QPs to obtain a single set of QPs.

Example 43: The method of example 42, wherein: the one or more quantizers for the convolutional kernel layers of respective one or more updated NN filters are combined into a single quantizer for the convolutional kernel layers; the one or more internals for convolutional kernels of the respective one or more updated NN filters are combined into a single internal for the convolutional kernel layers; the one or more quantizers for the bias layers of respective one or more updated NN filters are combined into a single quantizer for the bias layers; the one or more internals for the bias layers of the respective one or more updated NN filters are combined into a single internal for the bias layers; the one or more quantizers for the multiplier layers of the respective one or more updated NN filters are combined into a single quantizer for the multiplier layers; and the one or more internals for the multiplier layers of the respective one or more updated NN filters are combined into a single internal for the multiplier layers.

Example 44: The method of any of the examples 42 or 43, wherein the one or more QPs comprise the single set of QPs.

Example 45: The method of example 35 further comprising receiving, in or along a bitstream, at least one QP of the one or more QPs from an encoder.

Example 46: The method of example 45, wherein the at least one QP is carried within an adaptation parameter set (APS) that is associated with an update to the base or pretrained NN filter or with the updated NN filter.

Example 47: The method of example 45, wherein the at least one QP is carried within a supplemental enhancement information (SEI) message that is associated with an update to the base or pretrained NN filter or with the updated NN filter.

Example 48: The method of example 35, wherein the a decoder comprises a set of predetermined QPs, and wherein the method further comprises: receiving an indication, one or more QPs, and/or one or more QP updates, wherein the one or more QPs replace respective one or more predetermined QPs in the set of predetermined QPs, and wherein the one or more QP updates are used to update respective one or more predetermined QPs in the set of predetermined QPs based on an update rule that is predefined or based on the indication.

Example 49: The method of example 48, wherein the decoder comprises a predetermined quantizer and a predetermined internal for convolutional kernel layers, a predetermined quantizer and a predetermined internal for bias layers, a predetermined quantizer and a predetermined internal for multiplier layers.

Example 50: The method of example 49 further comprising receiving an adaptation parameter set (APS) comprising: an update to the base or pretrained NN filter; an update to the predetermined quantizer for the convolutional kernel layers; an update to the predetermined internal for the convolutional kernel layers; an update to the predetermined internal for the multiplier layers; an updated quantizer for the multiplier layers; an update to the predetermined quantizer for the bias layers; or an update to the predetermined internal for the bias layers.

Example 51: The method of example 48, wherein the decoder comprises: one or more predetermined QPs for convolutional kernel layers, wherein a first one or more convolutional kernel layers of the convolutional kernel layers use a same QP and a second one or more convolutional kernel layers of the convolutional kernel layers use different QPs; one or more predetermined QPs for bias layers; and one or more predetermined QPs for multiplier layers.

Example 52: The method of example 51 further comprising: receiving an adaptation parameter set (APS) comprising: an update to the base or pretrained NN filter; one or more updates to one or more predetermined quantizers for the convolutional kernel layers; one or more updates to one or more predetermined internals for the convolutional kernel layers; one or more updates to one or more predetermined internals for the multiplier layers; one or more updates to one or more predetermined quantizers for the bias layers; one or more updates to one or more predetermined internals for the bias layers; or one or more updated quantizers for the multiplier layers.

Example 53: A method comprising: signaling, in or along a bitstream, an update to a decoder; signaling, in or along the bitstream, at least one quantization parameters (QP) of one or more QPs to the decoder; and wherein the one or more QPs are used to quantize an updated neural network (NN) filter, and wherein the updated NN filter is based at least on a base or pretrained NN filter and on the update.

Example 54: The method of example 53, wherein at least another one QP of the one or more QPs is predetermined in an offline phase to generate at least one predetermined QP, and wherein the at least one predetermined QP is available at a decoder.

Example 55: The method of example 54, wherein the at least one predetermined QP is same or substantially same as a QP used to quantize the base or the pretrained NN filter.

Example 56: The method of any of the examples 53 to 55, wherein the updated NN filter uses same quantizers and internals as the quantizers and internals used to quantize the base or pretrained NN filter, and wherein a quantizer is used to quantize a parameter of a NN, and wherein an internal is used to quantize an input, an intermediate input, an output, or an intermediate output of the NN.

Example 57: The method of example 54, wherein the at least one predetermined QP is predetermined based on one or more other updated NN filters, and wherein the one or more other updated NN filters are updated during the offline phase.

Example 58: The method of example 53, wherein the updated NN filter is quantized based on data-driven quantization to obtain respective one or more sets of QPs.

Example 59: The method of example 58, wherein the respective one or more sets of QPs comprise one or more of the following: respective one or more quantizers for convolutional kernel layers; respective one or more internals for the convolutional kernel layers; respective one or more quantizers for bias layers; respective one or more internals for the bias layers; respective one or more quantizers for multiplier layers; or respective one or more internals for the multiplier layers.

Example 60: The method of example 59, the one or more sets of QPs are combined to obtain a single set of QPs.

Example 61: The method of example 60, wherein: the one or more quantizers for the convolutional kernel layers of respective one or more updated NN filters are combined into a single quantizer for the convolutional kernel layers; the one or more internals for convolutional kernels of the respective one or more updated NN filters are combined into a single internal for the convolutional kernel layers; the one or more quantizers for the bias layers of respective one or more updated NN filters are combined into a single quantizer for the bias layers; the one or more internals for the bias layers of the respective one or more updated NN filters are combined into a single internal for the bias layers; the one or more quantizers for the multiplier layers of the respective one or more updated NN filters are combined into a single quantizer for the multiplier layers; and the one or more internals for the multiplier layers of the respective one or more updated NN filters are combined into a single internal for the multiplier layers.

Example 62: The method of any of the examples 60 or 61, wherein the one or more QPs comprise the single set of QPs.

Example 63: The method of example 53 further comprising signaling, in or along the bitstream, at least one QP of the one or more QPs to the decoder.

Example 64: The method of example 63, wherein the at least one QP is carried or signaled within an adaptation parameter set (APS) that is associated with an update to the base or pretrained NN filter or with the updated NN filter.

Example 65: The method of example 63, wherein the at least one QP is carried or signaled within a supplemental enhancement information (SEI) message that is associated with an update to the base or pretrained NN filter or with the updated NN filter.

Example 66: The method of example 53 further comprising signaling an indication, one or more QPs, and/or one or more QP updates associated to respective one or more predetermined QPs comprised in the decoder, wherein the one or more QPs replace the respective one or more predetermined QPs, and wherein the one or more QP updates are intended to be used to update the respective one or more predetermined QPs based on an update rule that is predefined or based on the indication.

Example 67: The method of example 66 further comprising: signaling an adaptation parameter set (APS) comprising: an update to the base or pretrained NN filter; an update to the predetermined quantizer for convolutional kernel layers comprised at the decoder; an update to the predetermined internal for the convolutional kernel layers comprised at the decoder; an update to the predetermined internal for multiplier layers comprised at the decoder; an updated quantizer for the multiplier layers comprised at the decoder; an update to the predetermined quantizer for bias layers comprised at the decoder; or an update to the predetermined internal for the bias layers comprised at the decoder.

Example 68: The method of example 66 further comprising: signaling an adaptation parameter set (APS) comprising following to the decoder: an update to the base or pretrained NN filter; one or more updates to one or more predetermined quantizers for convolutional kernel layers; one or more updates to one or more predetermined internals for the convolutional kernel layers; one or more updates to one or more predetermined internals for multiplier layers; one or more updates to one or more predetermined quantizers for bias layers; one or more updates to one or more predetermined internals for the bias layers; or one or more updated quantizers for the multiplier layers.

Example 69: An apparatus comprising means for performing the methods as described in any of the examples 35 to 52 or 53 to 68.

Example 70: A computer readable medium comprising program instructions that, when executed by an apparatus, cause the apparatus to perform the methods as described in any of the examples 35 to 52 or 53 to 68.

Example 71: The computer readable medium of example 70, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 illustrates an example of modified video coding pipeline based on neural networks.

FIG. 5 illustrates an example neural network-based end-to-end learned coding.

FIG. 6 is a general illustration of the pipeline of a video coding for machines.

FIG. 7 illustrates an example of architecture of a neural network (NN) filter

FIG. 8 illustrates an example of encoder-side operations for overfitting a neural network based filter.

FIG. 9 illustrates an example of decoder or receiver side operations for updating a neural network based filter.

FIG. 10 is an example apparatus, which may be implemented in hardware, and is caused to, implement examples described herein.

FIG. 11 shows a representation of an example of non-volatile memory media used to store instructions that implement the examples described herein.

FIG. 12 is an example method to implement the embodiments described herein, in accordance with an embodiment.

FIG. 13 is an example method to implement the embodiments described herein, in accordance with an embodiment.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):

| | |
|---|---|
| 4CC | four character code |
| 5G | fifth generation cellular network technology |
| 5GC | 5G core network |
| a.k.a. | also known as |
| AVC | advanced video coding |
| CU | central unit |
| DSP | digital signal processor |
| DU | distributed unit |
| eNB | evolved Node B (for example, an LTE base station) |
| (or eNodeB) | |
| EN-DC | E-UTRA-NR dual connectivity |
| en-gNB or | node providing NR user plane and control plane |
| En-gNB | protocol terminations towards the UE, and acting |
| | as secondary node in EN-DC |
| E-UTRA | evolved universal terrestrial radio access, for |
| | example, the LTE radio access technology |
| F1 or F1-C | interface between CU and DU control interface |
| gNB | base station for 5G/NR, for example, a node |
| (or gNodeB) | providing NR user plane and control plane protocol |
| | terminations towards the UE, and connected via the |
| | NG interface to the 5GC |
| IEC | International Electrotechnical Commission |
| IoT | internet of things |
| ISO | International Organization for Standardization |
| ISOBMFF | ISO base media file format |
| JPEG | joint photographic experts group |
| LTE | long-term evolution |
| mdat | MediaDataBox |
| MIME | Multipurpose Internet Mail Extension |
| MME | mobility management entity |
| moov | MovieBox |
| MP4 | file format for MPEG-4 Part 14 files |
| MPEG | moving picture experts group |
| MPEG-2 | H.222/H.262 as defined by the ITU |
| MPEG-4 | audio and video coding standard for ISO/IEC 14496 |
| ng or NG | new generation |
| ng-eNB or | new generation eNB |
| NG-eNB | |
| NR | new radio (5G radio) |
| N/W or NW | network |
| PDCP | packet data convergence protocol |
| PHY | physical layer |
| PNG | portable network graphics |
| RAN | radio access network |
| RFC | request for comments |
| RLC | radio link control |
| RRC | radio resource control |
| RRH | remote radio head |
| RU | radio unit |
| Rx | receiver |
| SDAP | service data adaptation protocol |
| SGW | serving gateway |
| SMF | session management function |
| SPS | sequence parameter set |
| SVC | scalable video coding |
| S1 | interface between eNodeBs and the EPC |
| trak | TrackBox |
| Tx | transmitter |
| UE | user equipment |
| UICC | Universal Integrated Circuit Card |
| UPF | user plane function |
| URL | uniform resource locator |
| X2 | interconnecting interface between two |
| | eNodeBs in LTE network |
| Xn | interface between two NG-RAN nodes |

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for quantizing overfitted filters.

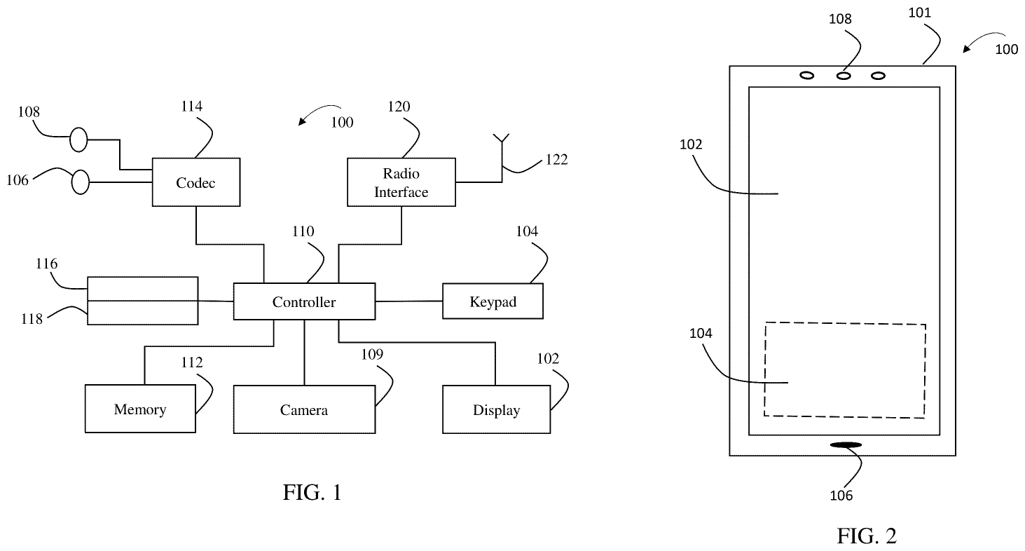

The following describes in detail a suitable apparatus and possible method for quantizing overfitted filters. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

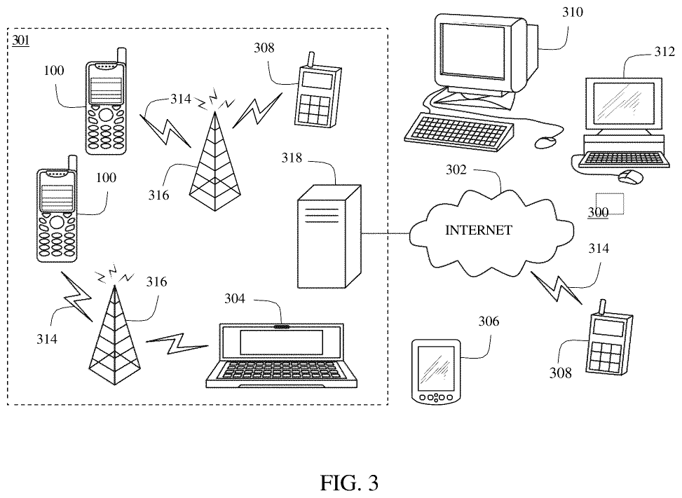

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

### Fundamentals of Neural Networks

A neural network (NN) may be described as a computation graph comprising several layers of computation. Each layer may include one or more units, where each unit performs an elementary computation. A unit is connected to one or more other units, and the connection may be associated with a weight. The weight may be used for scaling the signal passing through the associated connection. Weights are learnable parameters, e.g., values which can be learned from training data. There may be other learnable parameters, such as those of batch-normalization layers.

In some neural networks, such as convolutional neural networks for image classification, initial layers (those close to the input data) extract semantically low-level features such as edges and textures in images, whereas intermediate layers extract more high-level features. After the feature extraction layers there may be one or more layers performing a certain task, such as classification, semantic segmentation, object detection, denoising, style transfer, super-resolution, and the like.

Neural networks are being utilized in an ever-increasing number of applications for many different types of devices, such as mobile phones. Examples include image and video analysis and processing, social media data analysis, device usage data analysis, and the like.

One property of neural nets (and other machine learning tools) is that they are able to learn properties from input data, e.g., in a supervised way or in unsupervised way. Such learning is a result of a training algorithm, or of a meta-level neural network providing the training signal.

In general, the training algorithm includes changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss or loss function. Examples of losses are mean squared error, cross-entropy, etc. In recent deep learning techniques, training is an iterative process, where at each iteration the algorithm modifies the weights of the neural net to make a gradual improvement of the network's output, e.g., to gradually decrease the loss, by means of gradient descent technique. In one example, at each training iteration, gradients of the loss function with respect to one or more weights or parameters of the NN are computed, for example by backpropagation technique; the computed gradients are then used by an optimization routine, such as Adam or Stochastic Gradient Descent (SGD) to obtain an update to the one or more weights or parameters.

In various embodiment, the terms “model”, “neural network”, “neural net” and “network” may be used interchangeably, and also the weights of neural networks are sometimes referred to as learnable parameters or simply as parameters.

Training a neural network is an optimization process, but the final goal may be different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, e.g., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
when the network is learning at all—in this case, the training set error should decrease, otherwise the model is in the regime of underfitting.
when the network is learning to generalize—in this case, also the validation set error needs to decrease and to be not too much higher than the training set error. When the training set error is low, but the validation set error is much higher than the training set error, or it does not decrease, or it even increases, the model may be in the regime of overfitting. This means that the model has just memorized the training set's properties and performs well only on that set, but performs poorly on a set not used for tuning its parameters.

### Fundamentals of Video/Image Coding

Video codec includes an encoder that transforms the input video into a compressed representation suited for storage/transmission and a decoder that can decompress the compressed video representation back into a viewable form. Typically, an encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, e.g., the difference between the predicted block of pixels and the original block of pixels, is coded. This is typically done by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (a.k.a. reference pictures).

In temporal inter prediction, the sources of prediction are previously decoded pictures in the same scalable layer. In intra block copy (IBC; a.k.a. intra-block-copy prediction), prediction may be applied similarly to temporal inter prediction but the reference picture is the current picture and only previously decoded samples may be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, e.g., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g., the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

### Information on Neural Network Based Image/Video Coding

Recently, neural networks (NNs) have been used in the context of image and video compression, by following mainly two approaches.

In an example approach, NNs are used to replace one or more of the components of a traditional codec such as a VVC/H.266-compliant codec. Here, by “traditional” we mean those codecs whose components and their parameters are typically not learned from data by means of machine learning techniques. Some examples of components that may be implemented as neural networks are, but not limited to:
An in-loop filter, for example a NN that works as an additional in-loop filter with respect to the traditional loop filters, or a NN that works as the only additional in-loop filter, thus replacing any other in-loop filter.
Intra-frame prediction.
Inter-frame prediction.
Transform and/or inverse transform.
Probability model for lossless coding.

In another example approach, commonly referred to as “end-to-end learned compression” (or end-to-end learned codec), NNs are used as the main components of the image/video codecs. However, the codec may still comprise components which are not based on machine learning techniques. In this approach, two example design options are as follows:

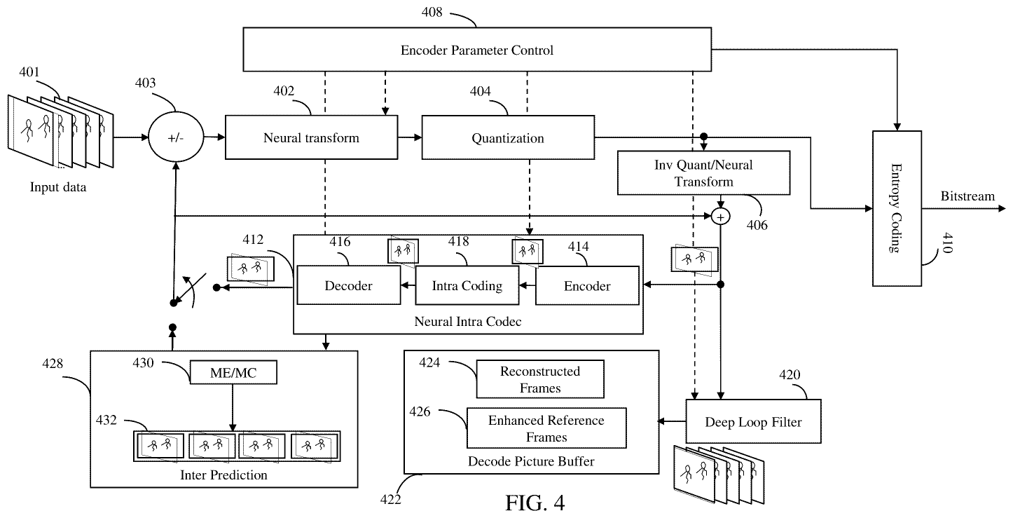

Option 1: re-use the traditional video coding pipeline, but replace most or all the components with NNs, as shown in FIG. 4.

Referring to FIG. 4, it illustrates an example of modified video coding pipeline based on neural networks. An example of neural network may include, but is not limited, a compressed representation of a neural network. FIG. 4 is shown to include following components:
A neural transform block or circuit 402: this block or circuit transforms the output of a summation/subtraction operation 403 to a new representation of that data, which may have lower entropy and thus be more compressible.
A quantization block or circuit 404: this block or circuit quantizes an input data 401 to a smaller set of possible values.
An inverse transform and inverse quantization blocks or circuits 406. These blocks or circuits perform the inverse or approximately inverse operation of the transform and the quantization, respectively.
An encoder parameter control block or circuit 408. This block or circuit may control and optimize some or all the parameters of the encoding process, such as parameters of one or more of the encoding blocks or circuits.
An entropy coding block or circuit 410. This block or circuit may perform lossless coding, for example, based on entropy. One popular entropy coding technique is arithmetic coding.
A neural intra-codec block or circuit 412. This block or circuit may be an image compression and decompression block or circuit, which may be used to encode and decode an intra frame. An encoder 414 may be an encoder block or circuit, such as the neural encoder part of an auto-encoder neural network. A decoder 416 may be a decoder block or circuit, such as the neural decoder part of an auto-encoder neural network. An intra-coding block or circuit 418 may be a block or circuit performing some intermediate steps between encoder and decoder, such as quantization, entropy encoding, entropy decoding, and/or inverse quantization.
A deep loop filter block or circuit 420. This block or circuit performs filtering of reconstructed data, in order to enhance it.
A decode picture buffer block or circuit 422. This block or circuit is a memory buffer, keeping the decoded frame, for example, reconstructed frames 424 and enhanced reference frames 426 to be used for inter prediction.
An inter-prediction block or circuit 428. This block or circuit performs inter-frame prediction, for example, predicts from frames, for example, frames 432, which are temporally nearby. An ME/MC 430 performs motion estimation and/or motion compensation, which are two key operations to be performed when performing inter-frame prediction. ME/MC stands for motion estimation/motion compensation.

In this example (Option 1), the forward and inverse transforms were replaced with two neural networks. Also, the loop filter is a neural network.

Option 2 (also referred to as end-to-end learned coding): re-design the whole pipeline as a neural network auto-encoder with a quantization and lossless coding in the middle part, as follows:
Encoder NN (also referred to as neural network based encoder, or NN encoder):
performs a non-linear transformation of the input. The output is typically referred to as latent tensor.
Quantization and lossless encoding of the encoder NN's output.
Lossless decoding and dequantization.
Decoder NN (also referred to as neural network based decoder, or NN decoder):
performs a non-linear inverse transformation from dequantized latent tensor to a reconstructed input.

It is to be understood that even in end-to-end learned approaches, there may be components which are not learned from data, such as the arithmetic codec.

More information on option 2 is provided in the following section.

### Further Information on Neural Network-Based End-to-End Learned Coding

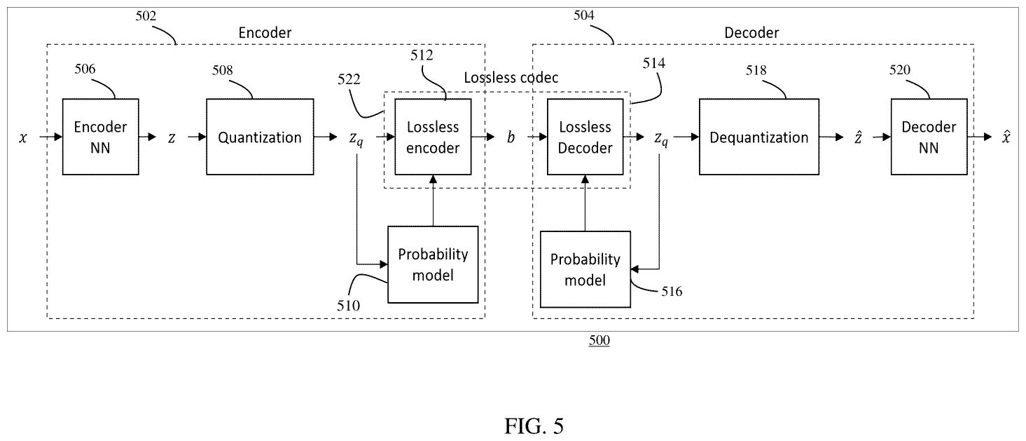

FIG. 5 illustrates an example neural network-based end-to-end learned coding, such as an end-to-end learned video coding system or an end-to-end learned image coding system. Even though some examples are provided with respect to coding images or videos, it is to be understood that other types of data may be coded in a similar way, such as audio, speech, text, features, and the like. As shown in FIG. 5, a neural network-based end-to-end learned coding system 500 includes an encoder 502 and a decoder 504.

The encoder comprises an encoder NN 506, a quantization or quantizer 508, a probability model 510, a lossless encoder 512 (for example, an arithmetic encoder). The decoder 504 comprises a lossless decoder 514 (for example, an arithmetic decoder), a probability model 516, a dequantization or dequantizer 518, a decoder NN 520.

It is to be noted that the probability model 510 present at encoder side and the probability model 516 present at decoder side may be same or substantially the same. For example, they may be two copies of the same probability model.

The lossless encoder 512 and the lossless decoder 514 form a lossless codec 522. The lossless codec 522 may be an entropy-based lossless codec. An example of lossless codec is an arithmetic codec, such as, a context-adaptive binary arithmetic coding (CABAC).

The encoder NN 506 and decoder NN 520 are typically two neural networks, or mainly comprise neural network components.

The probability models 510, 516 may also be neural networks and/or comprise mainly neural network components, and may be referred to as neural network based probability models or learned probability models.

Sometimes, the term lossless codec may refer to a system that comprise also the probability model, in addition to, for example, an arithmetic encoder and an arithmetic decoder.

The quantizer 508, the dequantizer 518, and the lossless codec 522 are typically not based on neural network components, but they may also potentially comprise neural network components.

The encoder NN 506 takes an input x, which may comprise, for example, an image to be compressed. The encoder NN 506 outputs a latent tensor z. In one example, the latent tensor may be a 3D tensor, where the three dimensions of such tensor represent a channel dimension, a vertical dimension (also sometimes referred to as height dimension) and a horizontal dimension (also sometimes referred to as width dimension). In another example, the latent tensor may be a 4D tensor, where the four dimensions of such tensor represent sample dimension (also sometimes referred to as batch dimension, which is the dimension along which different samples of data may be placed), a channel dimension, a vertical dimension (also sometimes referred to as height dimension) and a horizontal dimension (also sometimes referred to as width dimension). The latent tensor is input to the quantizer 508 or a quantization operation, obtaining a quantized latent tensor z_{q}. The quantized latent tensor is lossless-encoded into a bitstream b by the lossless encoder 512, based also on the output of the probability model 510. In particular, the probability model 510 takes as input at least part of the quantized latent tensor and outputs an estimate of a probability, an estimate of a probability distribution, or an estimate of one or more parameters of a probability distribution for one or more elements of the quantized latent tensor. The bitstream represents an encoded or compressed version of the input x.

The bitstream is lossless-decoded by the lossless decoder 514 also based on the output of the probability model 516 present at the decoder side, obtaining a quantized latent tensor z_{q}. The quantized latent tensor is dequantized by the dequantizer 518, obtaining a reconstructed latent tensor z_{q}. The reconstructed latent tensor is input to the decoder NN 520, obtaining a reconstructed input \hat{x}, e.g., a reconstructed version of the input x. The reconstructed input may also be referred to as reconstructed data, reconstruction, decoded data, decoded input, decoded output, and the like.

The coding system 500 is a simplified description of an end-to-end learned codec, and it is to be understood that more sophisticated designs or variation of this design are possible.

The neural network components, or a subset of the neural network components, of an end-to-end learned codec may be trained by minimizing a rate-distortion loss function:

$$L = D + λ R ,$$

where D is a distortion loss term, R is a rate loss term, and X is a weight that controls the balance between the two losses.

The distortion loss term may be referred to also as reconstruction loss term, or simply reconstruction loss.

The rate loss term may be referred to simply as rate loss.

The distortion loss term measures the quality of the reconstructed or decoded output, and may comprise (but may not be limited to) one or more of the following:
Mean square error (MSE)
Structure similarity (SSIM)
MS-SSIM
Losses derived from the use of a pretrained neural network. For example, error(f1, f2), where f1 and f2 are the features extracted by a pretrained neural network for the input data and the decoded data, respectively, and error( ) is an error or distance function, such as L1 norm or L2 norm.
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.
Loss that is related to a performance of one or more machine analysis tasks or to an estimated performance of one or more machine analysis tasks, where the one or more machine analysis tasks may comprise classification, object detection, image segmentation, instance segmentation, etc. In one example, the estimated performance of one or more machine analysis tasks may comprise a distortion computed based at least on a first set of features extracted from an output of the decoder and a second set of features extracted from a respective ground truth data, where the first set of features and the second set of features are output by one or more layers of a pretrained feature-extraction neural network.

Multiple distortion losses may be used and integrated into D, such as a weighted sum of MSE and SSIM.

The rate loss term may be used to train the encoder NN to output a low-entropy latent tensor, or a latent tensor such that the quantized latent tensor has low entropy, or a latent tensor such that the probability distribution of the quantized latent tensor can be better estimated or predicted by the probability model.

The rate loss term may be used to train the probability model to better estimate or predict the probability distribution of the quantized latent tensor.

Examples of the rate loss terms are the following:
In one example, the rate loss term is derived from the output of the probability model, and it represents the estimated entropy of the quantized latent representation, which indicates the number of bits necessary to represent the quantized latent tensor.
A sparsification loss, e.g., a loss that encourages the quantized latent tensor to comprise many zeros. Examples are L0 norm, L1 norm, L1 norm divided by L2 norm.

In order to train the neural network components, or a subset of the neural network components, of an end-to-end learned codec, one or more reconstruction losses and/or one or more rate losses may be used. In one example the one or more reconstruction losses and/or one or more rate losses are combined by means of a weighted sum. Typically, the different loss terms are weighted using different weights, and these weights determine how the final system performs in terms of rate-distortion performance. For example, when more weight is given to the reconstruction losses with respect to the rate losses, the system may learn to compress less but to reconstruct with higher accuracy (as measured by a metric that correlates with the reconstruction losses). These weights are usually considered to be hyper-parameters of the training process, and may be set manually by the person designing the training process, or automatically for example by grid search or by using additional neural networks.

In an example, the training process may be performed jointly with respect to the distortion loss D and the rate loss R. In another case, the training process may be performed in two alternating phases, where in a first phase only the distortion loss D may be used, and in a second phase only the rate loss R may be used.

For lossless video/image compression, the system may comprise only the probability model and lossless encoder and lossless decoder. The loss function would comprise only the rate loss, since the distortion loss is always zero (e.g., no loss of information).

In various embodiments, an inference phase, an inference stage, an inference time, or a test time, refers to a phase when a neural network or a codec is used for its purpose, such as encoding and decoding an input image.

### Information on Video Coding for Machines (VCM)

Reducing the distortion in image and video compression is often intended to increase human perceptual quality, as humans are considered to be the end users, e.g., consuming/watching the decoded images or videos. Recently, with the advent of machine learning, especially deep learning, there is a rising number of machines (e.g., autonomous agents) that analyze data independently from humans and that may even take decisions based on the analysis results without human intervention. Examples of such analysis are object detection, scene classification, semantic segmentation, video event detection, anomaly detection, pedestrian tracking, and the like. For example, such analysis tasks may be performed by neural networks.

It is likely that the device where the analysis takes place has multiple “machines” or neural networks (NNs). These multiple machines may be used in a certain combination which, for example, is determined by an orchestrator sub-system. The multiple machines may be used, for example, in succession, based on the output of the previously used machine, and/or in parallel. For example, a video may be analyzed by one machine (NN) for detecting pedestrians, by another machine (another NN) for detecting cars, and by another machine (another NN) for estimating the depth of all the pixels in the frames.

Example use cases and applications are self-driving cars, video surveillance cameras and public safety, smart sensor networks, smart TV and smart advertisement, person re-identification, smart traffic monitoring, drones, etc. In addition to image and video data, automatic analysis and processing is increasingly been performed for other types of data, such as audio, speech, text.

Compressing (and decompressing) data where the end user comprises machines (e.g., neural networks) is commonly referred to as compression or coding for machines. In the case of video data, it is referred to as video compression or coding for machines (VCM).

Compressing for machines may differ from compressing for humans, for example, with respect to the algorithms and technology used in the codec, or the training losses used to train any neural network components of the codec, or the evaluation methodology of codecs.

It is to be understood that, when considering the case of coding for machines, the term “receiver-side” or “decoder-side” may refer to a physical entity, an abstract entity, or a device which includes one or more machines, and runs these one or more machines on some encoded and eventually decoded video representation which is encoded by another physical or abstract entity or device, the “encoder-side device”.

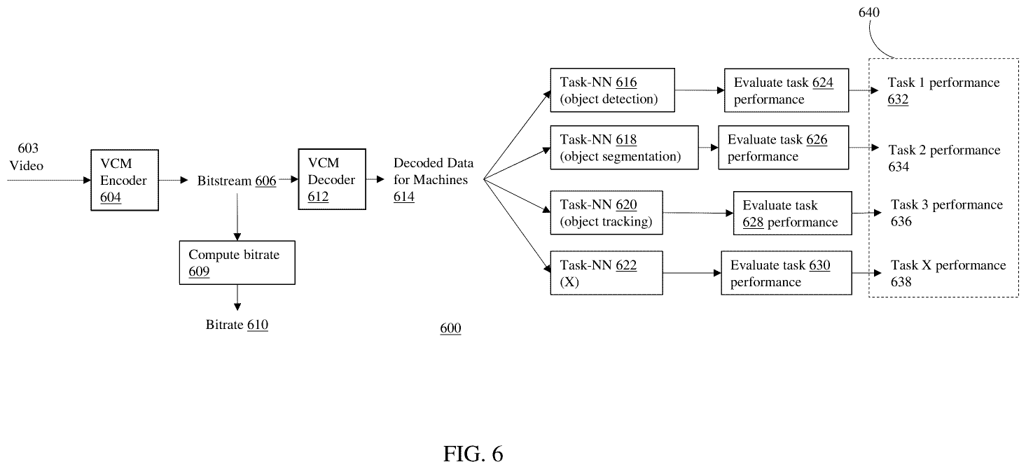

FIG. 6 is a general illustration of the pipeline 600 of a video coding for machines. A VCM encoder 604 encodes the input video 603 into a bitstream 606. A bitrate 610 may be computed 609 from the bitstream 606 in order to evaluate the size of the bitstream 606. A VCM decoder 612 decodes the bitstream 606 output by the VCM encoder 604. An output 614 of the VCM decoder 612 is referred in FIG. 6 as “Decoded data for machines”. This output 614 may be considered as the decoded or reconstructed video. However, in some implementations of this pipeline 600, this output 614 may not have the same or similar characteristics as the input video 603 which was input to the VCM encoder 604. For example, this output 614 may not be easily understandable by a human by simply rendering the data onto a screen. The output 614 of VCM decoder 612 is then input to one or more task neural networks (616, 618, 620, 622). In FIG. 6, for the sake of illustrating that there may be any number of task-NNs, there are three example task-NNs, namely a task-NN 616 for object detection, a task-NN 618 for object segmentation, a task-NN 3 for object tracking, and a non-specified one (Task-NN X 622). The goal of VCM is to obtain a low bitrate while guaranteeing that the task-NNs (616, 618, 620, 622) still perform well in terms of the evaluation metric associated to each task.

As shown in FIG. 6, a performance (632) of the first task (e.g., object detection) is evaluated (624) and a performance (634) of the second task (e.g., object segmentation) is evaluated (626), a performance (636) of the third task (e.g., object tracking) is evaluated (628), and a performance (638) of the unspecified task is evaluated (630). The evaluated performances (632, 634, 636, 638) are collectively given as 640.

It is to be understood that, in some cases, the VCM decoder may not be present. In an example, the machines are run directly on the bitstream. In another example, the VCM decoder may comprise only a lossless decoding stage, and the lossless decoded data is provided as input to the machines. In yet some other cases, the VCM decoder may comprise a lossless decoding stage following by a dequantization operation, and the loss-decoded and dequantized data is provided as input to the machines.

When a conventional video encoder, such as a H.266/VVC encoder, is used as a VCM encoder, one or more of the following approaches may be used to adapt the encoding to be suitable to machine analysis tasks:

One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
The quantization parameter (QP) may be adjusted spatially in a manner that ROIs are encoded using finer quantization step size(s) than other regions. For example, QP may be adjusted CTU-wise.
The video is preprocessed to contain only the ROIs, while the other areas are replaced by one or more constant values or removed.
The video is preprocessed so that the areas outside the ROIs are blurred or filtered.
A grid is formed in a manner that a single grid cell covers a ROI. Grid rows or grid columns that contain no ROIs are downsampled as preprocessing to encoding.

Quantization parameter of the highest temporal sublayer(s) is increased (e.g., a coarser quantization is used) when compared to practices for human watchable video.

The original video is temporally downsampled as preprocessing prior to encoding. A frame rate upsampling method may be used as postprocessing subsequent to decoding when machine analysis at the original frame rate is desired.

A filter is used to preprocess the input to the conventional encoder. The filter may be a machine learning based filter, such as a convolutional neural network.

It is to be understood that, in the context of video coding for machines, the terms “machine vision”, “machine vision task”, “machine task”, “machine analysis”, “machine analysis task”, “computer vision”, “computer vision task”, “task network” and “task” may be used interchangeably.

Also, it is to be understood that, in the context of video coding for machines, the terms “machine consumption” and “machine analysis” may be used interchangeably.

### Information on Neural Network Based Filtering

A neural network may be used for filtering or processing input data. Such a neural network may be referred to as a neural network based filter, a NN filter, a filter. A NN filter may comprise one or more neural networks, and/or one or more components that may not be categorized as neural networks.

The purpose of a NN filter may comprise, (but may not be limited to, visual enhancement, colorization, upsampling, super-resolution, inpainting, temporal extrapolation, generating content, and the like.

In some video codecs, a neural network may be used as filter in the encoding and decoding loop (also referred to simply as coding loop), and it may be referred to as neural network loop filter, or neural network in-loop filter. The NN loop filter may replace all other loop filters of an existing video codec, or may represent an additional loop filter with respect to the already present loop filters in an existing video codec.

In one example, a codec is a modified VVC/H.266 compliant codec (e.g., a VVC/H.266 compliant codec that has been modified and thus it may not be compliant to the VVC/H.266) that comprises one or more NN loop filters. An input to the one or more NN loop filters may comprise at least a reconstructed block or frames (simply referred to as reconstruction) or data derived from a reconstructed block or frame (e.g., the output of a conventional loop filter). The reconstruction may be obtained based on predicting a block or frame (e.g., by means of intra-frame prediction or inter-frame prediction) and performing residual compensation. The one or more NN loop filters may enhance the quality of at least one of their input, so that a rate-distortion loss is decreased. The rate may indicate a bitrate (estimate or real) of the encoded video. The distortion may indicate a pixel fidelity distortion such as the following:
Mean-squared error (MSE)
Mean absolute error (MAE)
Mean Average Precision (mAP) computed based on the output of a task NN (such as an object detection NN) when the input is the output of the post-processing NN.
Other machine task-related metric, for tasks such as object tracking, video activity classification, video anomaly detection, etc.

The enhancement may result into a coding gain, which may be expressed for example in terms of BD-rate or BD-PSNR.

A neural network filter may be used as post-processing filter for a codec, e.g., may be applied to an output of an image or video decoder in order to remove or reduce coding artifacts. In one example, the NN filter is used as a post-processing filter where the input comprises data that is output by or is derived from an output of a traditional decoder, such as a decoder that is compliant with the VVC/H.266 standard. In another example, the NN filter is used as a post-processing filter where the input comprises data that is output by or is derived from an output of a decoder of an end-to-end learned decoder.

### Input to an NN Filter

In the case of filtering images, a filter may take as input at least one or more first images to be filtered and may output at least one or more second images, where the one or more second images are the filtered version of the one or more first images. In one example, the filter takes as input one image and outputs one image. In another example, the filter takes as input more than one image and outputs one image. In another example, the filter takes as input more than one image and outputs more than one image.

It is to be understood that a filter may take as input also other data (also referred to as auxiliary data, or extra data) than the data that is to be filtered, such as data that can aid the filter to perform a better filtering than when no auxiliary data was provided as input. In one example, the auxiliary data comprises information about prediction data, and/or information about the picture type, and/or information about the slice type, and/or information about a Quantization Parameter (QP) used for encoding, and/or information about boundary strength, etc. In one example, the filter takes as input one image and other data associated to that image, such as information about the quantization parameter (QP) used for quantizing and/or dequantizing that image, and outputs one image.

### Example Architecture of a NN Filter

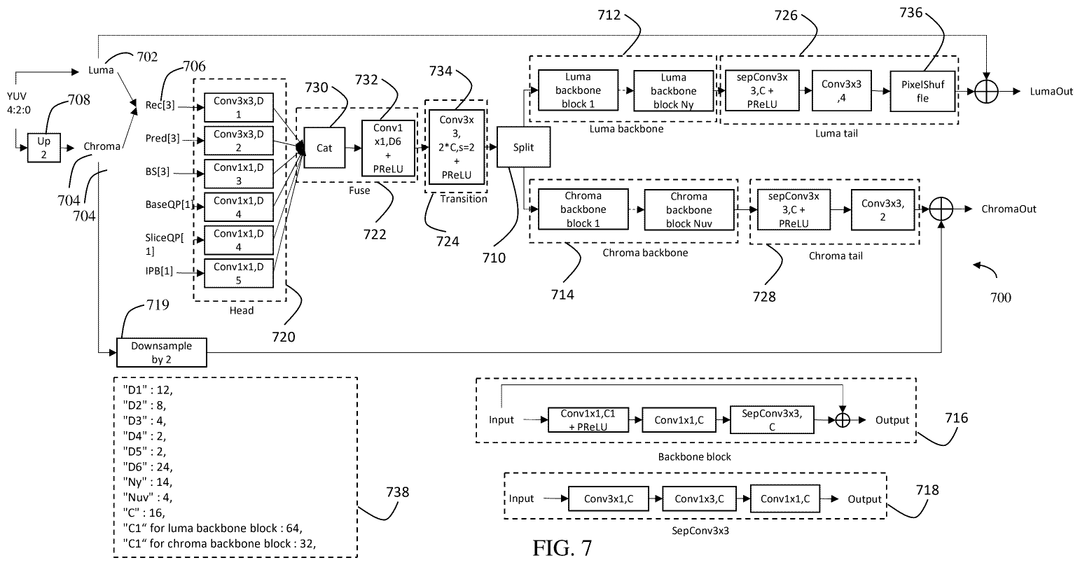

An example architecture of a NN filter is considered to describe various embodiments. FIG. 7 illustrates an example of architecture of the NN filter.

In FIG. 7, “luma” and “chroma” refer to the reconstructed luma and chroma that are to be enhanced by the NN filter, and may represent an intermediate result of an encoding or decoding operation. In one example, where the filter is a loop filter of a video codec, “luma” and “chroma” may represent the result of combining a predicted block with a decoded residual. The luma 702 and chroma 704 are concatenated to form the reconstruction Rec 706. The luma 702 and chroma 704 are assumed to have the same height and width. In case the format of data is YUV 420, or a format such that the chroma has smaller resolution than the luma, such as half height and half width with respect to the luma, then the chroma may be upsampled to match the height and width of the luma (and this upsampling operation is denoted as “Up2” 708 in FIG. 7 refers to upsampling by 2 in both the height dimension and the width dimension).

The terms Rec, Pred, BS, BaseQP, SliceQP, IPB represent the inputs to the NN filter 700 and each of those inputs is usually in the format of a tensor of shape B×C×H×W, where B indicates a batch size (e.g., number of pictures or blocks), C indicates a number of channels, H and W indicate a height and width, respectively. The square brackets and the number within them (e.g., Rec[3]), indicate the number of channels of the associated tensor. For example, Rec[3] indicates that the input tensor Rec includes 3 channels, thus has shape B×3×H×W, where the 3 channels may represent the luma channel, the Blue-Yellow Chrominance (Cb) channel and the Red-Green Chrominance (Cr) channel. The Cb channel and the Cr channel may be collectively referred to as chroma.

Pred refers to prediction. BS refers to boundary strength, BaseQP refers to the sequence-level quantization parameter (QP), SliceQP refers to the slice-level QP, IPB refers to the type of slice or type of picture (e.g., intra slice, P inter slice, B inter slice).

In some embodiments, Rec may be referred to as main input, or data to be filtered, whereas Pred, BS, BaseQP, SliceQP and IPB may be referred to as auxiliary input, or data not to be filtered.

Each block in FIG. 7 represents an operation, such as one or more NN layers. The block “ConvK1×K2,Z” indicates a convolutional layer with kernel size K1×K2 and number of kernels equal to Z. present, the term “+PReLU” indicates that a layer is followed by a Parameterized Rectified Linear Unit (PReLU). When present, the term “s=2” indicates that a convolutional layer has stride equal to 2; when not present, the convolutional layer has stride equal to 1. “Split 710 refers to an operation that splits a tensor across the channel dimension. Luma backbone block 712 and Chroma backbone block 714 indicate a backbone block used for filtering or processing the luma channel and the chroma channel, respectively; the architecture of a backbone block 716 shown in FIG. 7 comprises several layers and operations. “SepConv3×3” indicates a block that comprises a separable convolution; an illustration of the SepConv3×3 block 718 shown in FIG. 7 comprises several layers. “PixelShuffle” operation 736 refers to an operation that rearranges elements in a tensor of shape Bx(C*r*r)×H×W to a tensor of shape B×C×(H*r)×(W*r), where r is an upscale factor. “Downsample by 2” 719 indicates an operation that downsamples the input by a factor of 2. In particular, in FIG. 7, the input chroma is downsampled by 2. “LumaOut” and “ChromaOut” represent the filtered luma and the filtered chroma, respectively, e.g., the final outputs from the NN filter 700.

For the sake of simplicity, the NN filter architecture is figuratively organized into the following sections: head section 720, fuse section 722, transition section 724, the luma backbone section 712, the chroma backbone section 714, luma tail section 726, chroma tail section 728. However, it is to be noted that other possible organizations of the NN filter 700 into subsets or blocks or sections may be possible and may still be in the scope of the embodiments of the invention.

All the input tensors are input to respective convolutional layers that are part of the “head” section 720 of the NN filter 700. The outputs of those convolutional layers are tensors, referred to head tensors. As part of the operations of the “fuse” section 722 of the NN filter 700, the head tensors are concatenated 730 into a single tensor across the channel dimension. The concatenated tensor is input to a convolutional layer 732, followed by a non-linear activation function PreLU 734. The output of the fuse section is input to the “transition” section 724 of the NN filter 700, which comprises a convolutional layer with stride equal to 2, followed by a PReLU activation function. The output of the transition section 724 is a tensor of shape B×(2*C)×(H/2)×(W/2), and it's split 710 into two sub-tensors, where each subtensor is of shape B×C×(H/2)×(W/2). A first subtensor is used to filter the luma and a second subtensor is used to filter the chroma. The first subtensor is input to the “luma backbone” section 712, and the second subtensor is input to the “chroma backbone” section 714. The luma backbone section 712 comprises Ny luma backbone blocks, and the chroma backbone section 714 comprises Nuv chroma backbone blocks. The output of a backbone block is input to the next backbone block, until the last backbone block in the section. The output of the last luma backbone block is input to the “luma tail” section 726, that comprises a SepConv3×3 block, followed by a PReLU operation, a Conv3×3 layer and a PixelShuffle operation 736. The output of the PixelShuffle operation 736 is added to the input luma, in order to obtain LumaOut. The output of the last chroma backbone block is input to the “chroma tail” section 728, that comprises a SepConv3×3 block, followed by a PReLU operation, and a Conv3×3 layer. The output of the PixelShuffle operation 736 is added to the input chroma, in order to obtain ChromaOut.

In FIG. 7 example of the values 738 of various hyper-parameters of the NN are also indicated, such as the number of channels of convolutional layers, D1, D2, D3, D4, D5, D6, C, Cl, the number of luma and chroma backbone blocks Ny and Nuv.

### Information on Overfitting a Neural Network Filter

A NN filter can be adapted at test time based at least on part of the data to be encoded and/or decoded and/or post-processed.

Although, for simplicity, the case of a NN filter is being considered herein, similar adaptation may be performed for other coding tools and/or post-processing tools that are based on neural network technology. For example, a neural network based intra-frame prediction, or a neural network based inter-frame prediction, and the like.

Such operation may be referred to, for example, with one of the following terms, when their meaning is clear from the context: adaptation, content adaptation, overfitting, finetuning, optimization, specialization, and the like.

The NN filter that results from the adaptation process may be referred to, for example, with one of the following terms: adapted filter, content-adapted filter, overfitted filter, finetuned filter, optimized filter, specialized filter, and the like.

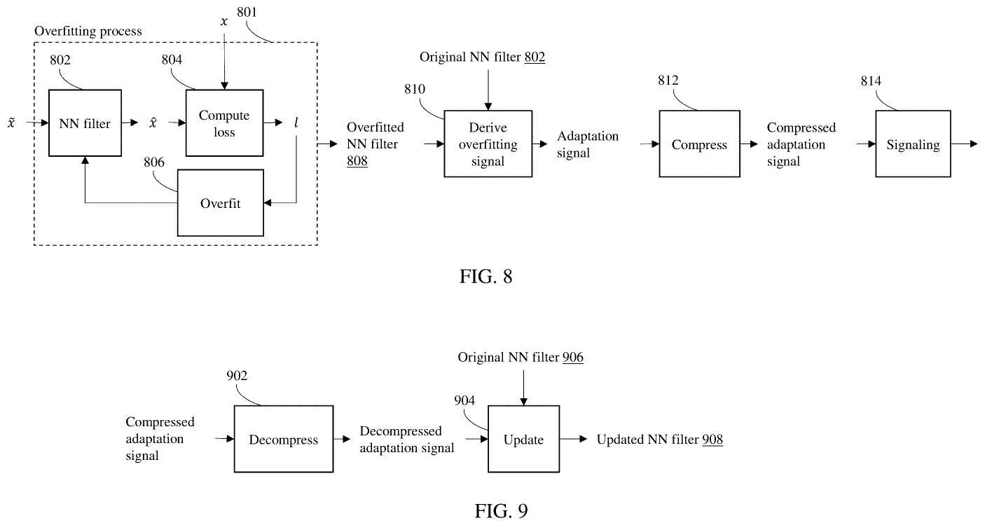

The overfitting process may be performed at encoder side based on a training process. The resulting overfitted filter is then used to derive an overfitting signal, or adaptation signal. The adaptation signal may be compressed and then signaled from encoder to decoder, in or along a bitstream that represents encoded data, such as an encoded image or video. FIG. 8 illustrates an example of such encoder-side operations.

Referring to FIG. 8, \tilde{x} represents an input to the NN filter 802, \tilde{x} represents an output of the NN filter 802, x represents a ground-truth data associated with \tilde{x}, compute loss circuit/module 804 computes a training loss l in order to overfit the NN filter 802, overfit circuit/module 806 uses l to overfit the NN filter. As a result of the overfitting process 801, an overfitted NN filter 808 is obtained, which is used by the derive overfitting circuit/module 810, together with the NN filter 802 (prior to being overfitted), to derive an adaptation signal. The adaptation signal is compressed 812 and signaled 814 to a decoder or receiver.

At decoder side, the compressed adaptation signal is received and is decompressed 902 to generate a decompressed adaptation signal. The decompressed adaptation signal, overfitting signal, or a signal derived from the overfitting signal, is used to update 904 the NN filter 906. The updated NN filter 908 is then used to filter one or more pictures, or one or more blocks. FIG. 9 illustrates an example of such decoder or receiver side operations.

The overfitted NN filter 808 that is obtained from the overfitting process at encoder side may be different from the updated NN filter 908 that is obtained from the updating process at decoder side. For example, one reason may be that the adaptation signal may be compressed in a lossy way. Thus, the former NN filter may be referred to as overfitted filter or adapted filter (or other similar terms, see above), and the latter NN filter may be referred to as updated filter.

### Overfitting Process Performed at Encoder Side

The adaptation process starts with an initial NN filter.

In an example, the initial NN filter is a pretrained NN filter, which was pretrained during an offline stage on a sufficiently large dataset.

In another example, the initial NN filter is a randomly initialized NN filter.

In the adaptation, one or more parameters of the NN filter may be adapted. Examples of such parameters may include (but may not be limited to) the following:
The bias terms of a convolutional neural network.
Multiplier parameters, that multiply one or more tensors produced by the NN filter, such as one or more feature tensors that are output by respective one or more layers of the NN filter.
Parameters of the kernels of a convolutional neural network.
Parameters of an adapter layer.
One or more arrays or tensors that are used as input to respective one or more layers of the NN filter.

The adaptation may be performed by means of a training process, e.g., by minimizing a loss function until a stopping criterion is met. The data used for this training process may comprise one or more pictures or blocks of input to the NN filter and associated respective one or more pictures or blocks of ground-truth data. In an example, where the filter is an in-loop filter, the input to the NN filter is reconstruction data, after prediction and residual compensation; the ground-truth data is the uncompressed data that is given as input to the encoder. In another example, where the filter is a post-processing filter, the input to the NN filter is decoded data (e.g., the output of a video decoder); the ground-truth data is the uncompressed data that is given as input to the encoder.

The loss function used during the training process may comprise one or more distortion loss functions (also referred to as reconstruction loss functions) and zero or more rate loss functions. A rate loss function may measure, for example, the cost in terms of bitrate of signaling any adaptation signal, such as updates to the parameters of the NN filter. A distortion loss function may comprise one of MSE, MS-SSIM, VMAF, and the like.

### Deriving the Adaptation Signal

The adaptation signal may be derived based on the adapted NN filter and on the original NN filter (e.g., the NN filter before the overfitting process).

In an example, the adaptation signal comprises an update to one or more parameters of the NN filter. Such an update may also be referred to as weight update, or parameter update. Such update may be computed, for example, by subtracting the values of the adapted parameters (e.g., the parameters of the adapted NN filter) from the corresponding values of the original parameters (e.g., the parameters of the original NN filter).

In another example, the adaptation signal comprises the parameters (of the NN filter) that were adapted, also referred to as updated parameters, or adapted parameters, or adapted weights, or overfitted parameters, and the like.

### Compression of Adaptation Signal

In order to keep the size of the adaptation signal low, the adaptation signal may go through one or more compression steps, such as sparsification, quantization and lossless coding.

In one example, an encoder that compresses the adaptation signal into a bitstream that is compliant with a neural network compression standard, such as MPEG NNC, may be used.

### Signaling

The compressed adaptation signal may be signaled from encoder to decoder in or along a bitstream that represents encoded image or video data.

In one example, the compressed adaptation signal is signaled in an Adaptation Parameter Set (APS) syntax structure of a video coding bitstream.

In another example, the compressed adaptation signal is signaled in a Supplemental Enhancement Information (SEI) message of a video coding bitstream.

Signaling may comprise also other information which is associated with the adaptation signal and that may be required for correctly parsing and/or decompressing and/or using the adaptation signal, such as any quantization parameters.

### Decoder or Receiver Side Operations

At decoder side, the signaled compressed adaptation signal is received and decompressed. The decompressed adaptation signal may then be used to update the NN filter.

In one example, where the adaptation signal comprises a weight update, where the weight update comprises one or more updates to respective one or more parameters of the NN filter, the one or more updates are added to the one or more parameters.

In another example, where the adaptation signal comprises one or more updated or adapted parameters, the one or more updated or adapted parameters are used to replace respective one or more parameters of the NN filter.

Once the NN filter has been updated based on the adaptation signal, the updated NN filter may be used for its purpose. For example, for filtering an input picture or an input block.

### Information on Quantization

A neural network may be quantized so that its parameters and/or inputs and/or outputs (e.g., intermediate outputs from NN layers, or final outputs from the last NN layer) are represented by a lower precision, e.g., with a smaller number of bits. In addition, a neural network may be quantized and integerized, e.g., its parameters, inputs and outputs may be represented as integer numbers. Herein, the term integerization may be used to refer to one or more operations for obtaining an integer number from a non-integer number, such as from a floating-point number. The result of integerization may be referred to an integer number or integerized number.

In one example, the parameters, inputs and outputs of a NN are initially represented as floating-point 32-bits numbers. After quantization and integerization, they are represented as integer 16-bits numbers.

In the rest of this document, the term or phrase “quantizing a neural network” (and similar terms or phrases) may refer either to only quantizing the NN or to quantizing and integerizing the NN.

In order to quantize a NN, one or more quantization parameters are used to modify the values of the parameters, inputs and outputs.

It is to be understood that a quantization may be performed based also on other information than one or more quantization parameters, such as a target number of bits (also referred to as target bit-depth).

In an example, a quantization parameter is used to multiply a floating-point value or a real number, followed by a rounding operation such as one of floor operation, ceiling operation round to nearest operation, or truncation operation. In another example, a quantization parameter is used to derive a multiplier value, where the multiplier value is used to multiply a floating-point value or a real number, followed by a rounding operation.

In another example, a quantization of a floating-point value or real number u is performed based on a quantization parameter q and a target bit-depth b, as follows:

$$v = min ( max ( ⌊ u \cdot {2}^{q} ⌉ , - {2}^{b - 1} ) , {2}^{b - 1} - 1 )$$

where v is a quantized value, min refers to computing a minimum value between two values, max refers to computing a maximum value between two values, └ ┐ refers to a rounding operation.

Quantization parameters (QPs) may be categorized into one or more categories, such as (but not limited to) the following:

“Quantizer”, used to quantize a parameter of the NN, such as the parameters of a convolutional layer.

“Internal”, used to quantize an input or an intermediate input or an output or an intermediate output of the NN, such as a feature tensor that is output by a convolutional layer. In the following, the term input may refer to both the initial input to a NN and an intermediate input to one of the layers of the NN, and the term output may refer to both the final output of a NN and an intermediate output of one of the layers of the NN.

It is to be noted that the above terms “quantizer” and “internal” may not be widely used in the machine learning or signal processing communities.

Based on whether parameters, inputs and outputs share the same QP values or not, there may be several cases, including (but not limited to) the following examples:

In a first example, each parameter, each input and each output of a NN may use potentially a different QP value.

In a second example, all parameters of a NN may use a first QP value, all inputs of a NN may use a second QP value, all outputs of a NN may use a third QP value.

In a third example, one or more sets of parameters of a NN associated to respective one or more types of NN layer may use respective one or more first QP values, one or more inputs to respective one or more types of NN layer may use respective one or more second QP values, and/or one or more outputs from respective one or more types of NN layer may use respective one or more third QP values.

In a fourth example, one or more parameters may use respective one or more first QP values, one or more inputs may use respective one or more second QP values, and one or more outputs may use respective one or more third QP values.

In an example, a NN comprises three types of layers, namely convolutional kernel layers, bias sublayer, multiplier layers (where a multiplier layer comprises multipliers that multiply their input). The parameters of the convolutional kernel layers are quantized by using a first quantizer value, the output of the convolutional kernel layers are quantized by using a first internal value, the parameters of the bias layers are quantized by using a second quantizer value, the outputs of the bias layers are quantized by using a second internal value, the parameters of the multiplier layers (e.g., the multiplier parameters) are quantized by using a third quantizer value, the outputs of the multiplier layers are quantized by using a third internal value.

Quantization of a NN filter

In the context of a NN filter, the NN filter may be quantized and then be part of a decoder (e.g., in the case of an in-loop NN filter) or a receiver (e.g., in the case of a post-processing NN filter).

### Terminology

In various embodiments, the terms frame, picture, and image may be used interchangeably.

For example, the input and output to an end-to-end learned codec may be pictures. The input and output of a NN filter may be pictures.

It is to be understood that also the term block, when it refers to a portion of a picture, may be simply referred to as frame or picture or image. In other words, at least some of the embodiments herein, even when described as applied to a picture, may be applicable also to a block, e.g., to a portion of a picture.

An example problem addressed by various embodiments is of filtering an input data item, such as an image or a video frame, for one or more purposes including: enhancing the visual quality, enhancing machine analysis results, and the like.

More specifically, various embodiments address the problem of, for example, quantizing an overfitted or updated filter.

### General Information

While at least some embodiments are described such that the input and output data are in the form of images or (video) frames or pictures, those embodiments may be applicable also to other types of data, such as audio frames. Furthermore, while at least some embodiments are described by considering a full image, those embodiments may be applicable also to one or more blocks or portions of an image.

In one or more embodiments, an intra-coded frame may be referred to as intra frame; similarly, an inter-coded frame may be referred to as inter frame.

In the following embodiments, the term “updated NN filter” is used to refer to a NN filter that has been updated with an adaptation or overfitting signal, such as with a weight-update that has been obtained based on an overfitting process and eventually based on a compression and decompression process. The term “pretrained NN filter” or “base NN filter” is used to refer to a NN filter that is not the result of an updating or overfitting process. When it is clear from the context, the term “NN filter” may refer to a pretrained or base NN filter.

When using the term quantization parameter (or simply QP), it may refer to the value of a quantization parameter.

### Example Embodiments

In an embodiment, an updated NN filter is quantized at a decoder or receiver side by using one or more quantization parameters (QPs), where the updated NN filter is based at least on a base or pretrained NN filter and on an update.

In an additional embodiment, at least one of the one or more QPs is predetermined in an offline phase, such as a phase of development of the decoder or receiver, and is available at the decoder or receiver side. The at least one of the one or more QPs that is predetermined may be referred to as “the at least one predetermined QP” in some of the embodiments herein.

In an additional embodiment, the at least one predetermined QP is same (e.g., it has the same or substantially the same value) as a QP used to quantize the base NN filter.

In an example, an updated NN filter uses the same quantizers and internals as the quantizers and internals used to quantize the base filter.

In an additional embodiment, the at least one predetermined QP was predetermined based on one or more other updated NN filters, where the one or more other updated NN filters may have been updated during an offline phase, such as a phase of development of the decoder or receiver.

In an example, during a development phase of the decoder, one or more updated NN filters are determined. Then, the one or more updated NN filters are quantized, for example, by means of data-driven quantization, obtaining respective one or more sets of QPs, such as respective one or more quantizers for the convolutional kernels, respective one or more internals for the convolutional kernels, respective one or more quantizers for the bias layers, respective one or more internals for the bias layers, respective one or more quantizers for the multiplier layers, respective one or more internals for the multiplier layers. Then, the one or more sets of QPs may be combined in order to obtain a single set of QPs, for example, by means of averaging in order to determine average QP values, or by means of determining the most common QP values. For example, the one or more quantizers for the convolutional kernels of the respective one or more updated NN filters may be combined (e.g., averaged) into a single quantizer for the convolutional kernels, and the one or more internals for the convolutional kernels of the respective one or more updated NN filters may be combined (e.g., averaged) into a single internal for the convolutional kernels, and so on, until obtaining a single quantizer for the convolutional kernels, a single internal for the convolutional kernels, a single quantizer for the bias layers, a single internal for the bias layers, a single quantizer for the multiplier layers, a single internal for the multiplier layers. Then, the single set of QPs may be included into the decoder. At test time, e.g., when the decoder decodes a bitstream, an updated NN filter may be quantized by using the single set of QPs.

It is to be noted that, in some cases, different layers of the same type may be quantized by using different QP values and, in other cases, different layers of the same type may be quantized by using a same QP value. For example, a first convolutional layer and a second convolutional layer of a NN filter may be quantized by using a different quantizer, whereas the second convolutional layer and a third convolutional layer may be quantized by using a same quantizer.

In an additional embodiment, at least one of the one or more QPs is signaled from an encoder to the decoder or receiver, in or along a bitstream.

In an example, the at least one QP may be carried within an adaptation parameter set (APS) that is associated with an update to the NN filter or with an updated NN filter, such as a Neural Network Filter Update APS.

In another example, the at least one QP may be carried within a supplemental enhancement information (SEI) message that is associated with an update to the NN filter or with an updated NN filter, such as a neural network post-filtering characteristics (NNPFC) SEI message.

In an example, a decoder includes a set of predetermined QPs and an encoder signals to the decoder one or more QPs and/or one or more QP updates, where the one or more QPs may replace respective one or more predetermined QPs in the set of predetermined QPs, and where the one or more QP updates may be used to update respective one or more predetermined QPs in the set of predetermined QPs based on an update rule that may be predefined or for which an indication may be signaled from encoder to decoder.

As an extension of the previous example, the decoder includes a predetermined quantizer and a predetermined internal for the convolutional kernel layers, a predetermined quantizer and a predetermined internal for the bias layers, a predetermined internal for the multiplier layers. The encoder signals to the decoder an APS that may comprise (but may not be limited to) one or more of the following:
An update to the NN filter, such as a weight update;
An update to the predetermined quantizer for the convolutional kernel layers;
An update to the predetermined internal for the convolutional kernel layers;
An update to the predetermined internal for the multiplier layers;
An update to the predetermined quantizer for the bias layers; or
An updated quantizer for the multiplier layers.

As another extension of the previous example, the decoder includes one or more predetermined QPs for convolutional kernel layers (e.g., one QP for each convolutional kernel layer, or some convolutional kernel layers use a same QP and some other convolutional kernel layers use different QPs), and includes one or more predetermined QPs for bias layers, and includes one or more predetermined QPs for multiplier layers. The encoder signals to the decoder an APS that may comprise (but may not be limited to) one or more of the following:
An update to the NN filter, such as a weight update;
One or more updates to one or more predetermined quantizers for the convolutional kernel layers;
One or more updates to one or more predetermined internals for the convolutional kernel layers;
One or more updates to one or more predetermined internals for the multiplier layers;
One or more updates to one or more predetermined quantizers for the bias layers; or
One or more updated quantizers for the multiplier layers.

The following table is an example syntax table for a neural network filter update APS that comprises indications of QPs and/or QP updates for an updated NN filter.

| | Descriptor |
|---|---|
| nn_filter_update_data( ) { | |
| for( i = 0; i < 3; i++ ) { | |
| nnfu_num_layers_qp_mod[ i ] | ue(v) |
| for( j = 0; j < nnfu_num_layers_qp_mod[ i ]; j++ ) | |
| if( j == 0 \|\| ( j > 0 && NumNNFilterLayers − qpLayerIdx[ i ][ j − 1 ] − 1 > | |
| nnfu_num_layers_qp_mod[ i ] − j ) ) | |
| nnfu_qp_layer_delta[ i ][ j ] | u(v) |
| } | |
| for( i = 0; i < NumNNFilterLayers; i++ ) | |
| nnfu_biasq_diff[ i ] | se(v) |
| nnfu_multq_minus10[ i ] | se(v) |
| nnfu_bitstream_size_minus1 | u(15) |
| while( !byte_aligned( ) ) | |
| nnfu_alignment_zero_bit | b(1) |
| for( I = 0; I <= nnfu_bitstream_size_minus1; i++ ) | |
| nnfu_payload_byte[ I ] | u(8) |
| } | |

The following paragraphs represent example semantics related to the above syntax table.
nnfu_num_layers_qp_mod[i] specifies the count of layers for which the quantizer parameter (“quantizer” or “internal”) is modified relative to a predetermined value. When i==0, the quantization parameter is a “quantizer” of a convolutional kernel layer, and the predetermined value is 14. When i==1, the quantization parameter is an “internal” of a convolutional kernel layer, and the predetermined value is 0. When i==2, the quantization parameter is an “internal” of a multiplier layer, and the predetermined value is 0.
nnfu_qp_layer_delta[i][j] is used to derive the index of the NN layer for which the quantizer or internal is modified. When nnfu_qp_layer_delta[i][j] is not present for any value of j in the range of 0 to nnfu_num_layers_qp_mod[i]−1, inclusive, it is inferred to be equal to 0. The value of qpLayerIdx[i][j] indicates the index of the NN layer for which the quantization parameter is decreased by 1 (when i==0) or increased by 1 (when i==1 and i==2) relative to the respective predetermined quantization parameter. The values of qpLayerIdx[i][j] are derived as follows:

```
for( i = 0; i < 3; i++ ) {
  for( j = 0; j < nnfu_num_layers_qp_mod[ i ]; j++ )
    if( j == 0 )
      qpLayerIdx[ i ][ j ] = nnfu_qp_layer_delta[ i ][ j ]
    else
      qpLayerIdx[ i ][ j ] = qpLayerIdx[ i ][ j − 1 ] + nnfu_qp_layer_delta[ i ][ j ] +
1
```

When j is equal to 0, the length of the syntax element is Ceil(Log2(NumNNFilterLayers))bits. When j is greater than 0, the length of the syntax element is Ceil(Log2(NumNNFilterLayers−qpLayerIdx[i][j−1]))bits.
nnfu_biasq_diff[i] specifies the difference of the quantizer of the bias values of the NN layer with index i relative to the respective quantizer of the base neural network.
nnfu_multq_minus10[i] plus 10 specifies the quantizer of the multiplier values of the NN layer with index i.
nnfu_alignment_zero_bit shall be equal to 0.
nnfu_bitstream_size_minusi+1 specifies the count of bytes in nnfu_payload_byte.
nnfu_payload_byte comprises the byte sequence representing the size of the model QPs, the model QPs and the bitstream conforming to ISO/IEC 15938-17. In particular, nnfu_payload_byte[0] specifies the size of the model QPs. Let NnfuQPsSize be equal to nnfu_payload_byte[0] and NnfuBitstreamSizeMinusl be equal to nnfu_bitstream_size_minusi: the bytes from nnfu_payload_byte[1] to nnfu_payload_byte[NnfuQPsSize] comprises the model QPs and the bytes from nnfu_payload_byte[NnfuQPsSize+1] to nnfu_payload_byte[NnfuBitstreamSizeMinusl] shall be a complete bitstream that conforms to ISO/IEC 15938-17 and provides an update relative to the base neural-network filter associated with the same aps_adaptation_parameter_set_id

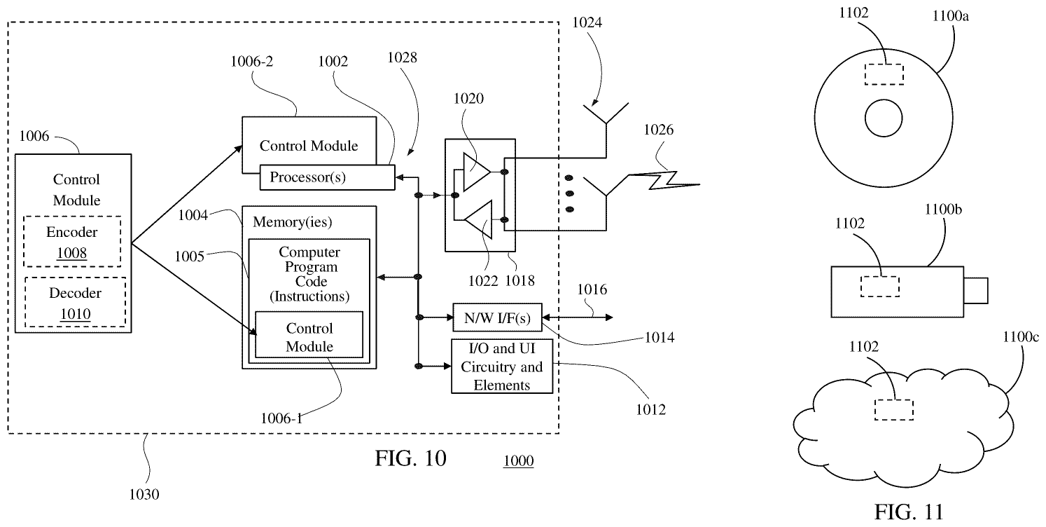

FIG. 10 is an example apparatus 1000, which may be implemented in hardware, configured to implement the examples described herein. The apparatus 1000 comprises at least one processor 1002 (e.g., an FPGA and/or CPU), at least one memory 1004 including computer program code 1005, the computer program code 1005 having instructions to carry out the methods described herein, wherein the at least one memory 1004 and the computer program code 1005 are configured to, with the at least one processor 1002, cause the apparatus 1000 to implement circuitry, a process, component, module, or function (implemented with control module 1006) to implement the examples described herein, including quantizing overfitted filters. Optionally included encoder 1008 of the control module 1006 implements encoding based on the examples described herein, and optionally included decoder 1010 implements decoding based on the examples described herein. The at least one memory 1004 may be a non-transitory memory, a transitory memory, a volatile memory (e.g. RAM), or a non-volatile memory (e.g., ROM).

The apparatus 1000 includes a display and/or I/O interface 1012, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1000 includes one or more communication e.g. network (N/W) interfaces (I/F(s)) 1014. The communication I/F(s) 1014 may be wired and/or wireless and communicate over the Internet/other network(s) via any communication technique including via one or more links 1016. The communication I/F(s) 1014 may comprise one or more transmitters or one or more receivers.

The transceiver 1018 comprises one or more transmitters 1020 and one or more receivers 1022. The transceiver 1018 and/or communication I/F(s) 1014 may comprise standard well-known components such as an amplifier, filter, frequency-converter, (de)modulator, and encoder/decoder circuitries and one or more antennas, such as antennas 1024 used for communication over wireless link 1026.

The control module 1006 of the apparatus 1000 comprises one of or both parts 1006-1 and/or 1006-2, which may be implemented in a number of ways. The control module 1006 may be implemented in hardware as control module 1006-1, such as being implemented as part of the at least one processor 1002. The control module 1006-1 may be implemented also as an integrated circuit or through other hardware such as a programmable gate array. In another example, the control module 1006 may be implemented as control module 1006-2, which is implemented as computer program code (having corresponding instructions) 1005 and is executed by the at least one processor 1002. For instance, the at least one memory 1004 store instructions that, when executed by the at least one processor 1002, cause the apparatus 1000 to perform one or more of the operations as described herein. Furthermore, the at least one processor 1002, the at least one memory 1004, and example algorithms (e.g., as flowcharts and/or signaling diagrams), encoded as instructions, programs, or code, are means for causing performance of the operations described herein.

The apparatus 1000 to implement the functionality of control module 1006 may correspond to any of the apparatuses depicted herein. Alternatively, apparatus 1000 and its elements may not correspond to any of the other apparatuses depicted herein, as apparatus 1000 may be part of a self-organizing/optimizing network (SON) node or other node, such as a node in a cloud.

The apparatus 1000 may also be distributed throughout the network including within and between apparatus 1000 and any network element (such as a base station and/or terminal device and/or user equipment).

Interface 1028 enables data communication and signaling between the various items of apparatus 1000, as shown in FIG. 10. For example, the interface 1028 may be one or more buses such as address, data, or control buses, and may include any interconnection mechanism, such as a series of lines on a motherboard or integrated circuit, fiber optics or other optical communication equipment, and the like. Computer program code (e.g. instructions) 1005, including control module 1006 may comprise object-oriented software configured to pass data or messages between objects within computer program code 1005. The apparatus 1000 need not comprise each of the features mentioned, or may comprise other features as well. The various components of apparatus 1000 may at least partially reside in a housing 1030, or a subset of the various components of apparatus 1000 may at least partially be located in different housings, which different housings may include housing 1030.

FIG. 11 shows a schematic representation of non-volatile memory media 1100a (e.g. computer/compact disc (CD) or digital versatile disc (DVD)) and 1100b (e.g. universal serial bus (USB) memory stick) and 1100c (e.g. cloud storage for downloading instructions and/or parameters 1102 or receiving emailed instructions and/or parameters 1102) storing instructions and/or parameters 1102 which when executed by a processor allows the processor to perform one or more of the operations of the methods described herein. Instructions and/or parameters 1102 may represent or correspond to a non-transitory computer readable medium.

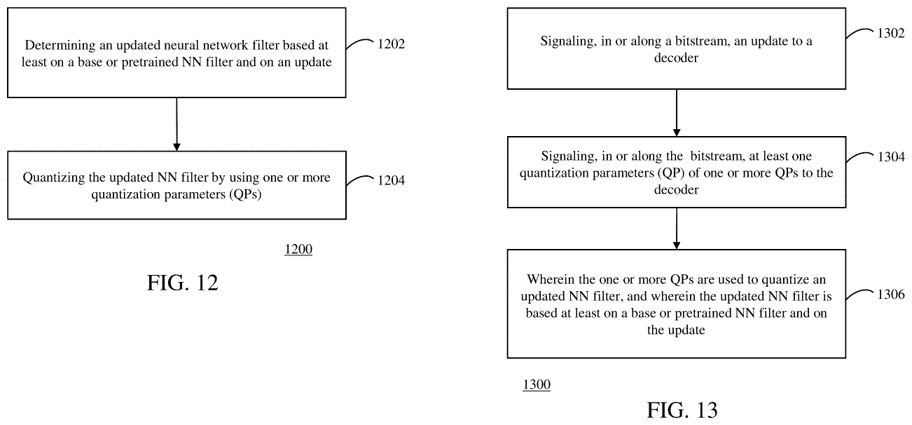

FIG. 12 is an example method to implement the embodiments described herein, in accordance with an embodiment. At 1202, the method 1200 includes determining an updated neural network filter based at least on a base or pretrained NN filter and on an update. At 1204, the method 1200 includes quantizing the updated NN filter by using one or more quantization parameters (QPs).

In an embodiment, at least one QP of the one or more QPs is predetermined in an offline phase to generate at least one predetermined QP, and wherein the at least one predetermined QP is available at a decoder.

In an embodiment, the at least one predetermined QP is same or substantially same as a QP used to quantize the base or the pretrained NN filter.

The method 1200 may be performed with an apparatus described herein, for example, any apparatus of FIG. 1 to FIG. 3, FIG. 10, or any other apparatus described herein.

FIG. 13 is an example method to implement the embodiments described herein, in accordance with an embodiment. At 1302, the method 1300 includes signaling, in or along a bitstream, an update to a decoder. At 1304, the method 1300 includes signaling, in or along the bitstream, at least one quantization parameters (QP) of one or more QPs to the decoder. At 1306, the method 1300 includes wherein the one or more QPs are used to quantize an updated NN filter, and wherein the updated NN filter is based at least on a base or pretrained NN filter and on the update.

The method 1300 may be performed with an apparatus described herein, for example, any apparatus of FIG. 1 to FIG. 3, FIG. 10, or any other apparatus described herein.

In an embodiment, at least one QP of the one or more QPs is predetermined in an offline phase to generate at least one predetermined QP, and wherein the at least one predetermined QP is available at a decoder.

In an embodiment, the at least one predetermined QP is same or substantially same as a QP used to quantize the base or the pretrained NN filter.

As described above, FIGS. 12 and 13 include flowcharts of an apparatus (e.g. 100, or 1000) any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g. 112 or 1004) of an apparatus employing an embodiment of the present invention and executed by processing circuitry (e.g., 110, or 1002) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 12 and 13. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some embodiments have been described in relation to one or more neural networks performing visual temporal extrapolation. It is to be understood that embodiments can be realized with any generative modelling neural networks.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
determining an updated neural network filter based at least on a base or pretrained neural network (NN) filter and on an update; and
quantizing the updated NN filter by using one or more quantization parameters (QPs).

2. The apparatus of claim 1, wherein at least another one QP of the one or more QPs is predetermined in an offline phase to generate at least one predetermined QP, and wherein the at least one predetermined QP is available at the apparatus.

3. The apparatus of claim 2, wherein the at least one predetermined QP is same or substantially same as a QP used to quantize the base or the pretrained NN filter.

4. The apparatus of claim 1, wherein the apparatus is caused to perform: receiving, in or along a bitstream, at least one QP of the one or more QPs from an encoder.

5. The apparatus of claim 1, wherein the apparatus comprises a set of predetermined QPs, and wherein the apparatus is caused to perform: receiving an indication, one or more QPs and/or one or more QP updates, wherein the one or more QPs replace respective one or more predetermined QPs in the set of predetermined QPs, and wherein the one or more QP updates are used to update respective one or more predetermined QPs in the set of predetermined QPs based on an update rule that is predefined or based on the indication.

6. An apparatus comprising:
at least one processor; and
at least one memory storing instructions that, when executed by the at least one processor, cause the apparatus at least to perform:
signaling, in or along a bitstream, an update to a decoder;
signaling, in or along the bitstream, at least one quantization parameters (QP) of one or more QPs to the decoder; and
wherein the one or more QPs are used to quantize an updated neural network (NN) filter, and wherein the updated NN filter is based at least on a base or pretrained NN filter and on the update.

7. The apparatus of claim 6, wherein at least another one QP of the one or more QPs is predetermined in an offline phase to generate at least one predetermined QP, and wherein the at least one predetermined QP is available at the decoder.

8. The apparatus of claim 7, wherein the at least one predetermined QP is same or substantially same as a QP used to quantize the base or the pretrained NN filter.

9. The apparatus of claim 6, wherein the apparatus is caused to perform: signaling, in or along the bitstream, at least one QP of the one or more QPs to the decoder.

10. The apparatus of claim 6, wherein the apparatus is further caused to perform: signaling an indication, one or more QPs, and/or one or more QP updates associated to respective one or more predetermined QPs comprised in the decoder, wherein the one or more QPs replace the respective one or more predetermined QPs, and wherein the one or more QP updates are intended to be used to update the respective one or more predetermined QPs based on an update rule that is predefined or based on the indication.

11. A method comprising:
determining an updated neural network filter based at least on a base or pretrained neural network (NN) filter and on an update; and
quantizing the updated NN filter by using one or more quantization parameters (QPs).

12. The method of claim 11, wherein at least another one QP of the one or more QPs is predetermined in an offline phase to generate at least one predetermined QP, and wherein the at least one predetermined QP is available at a decoder.

13. The method of claim 12, wherein the at least one predetermined QP is same or substantially same as a QP used to quantize the base or the pretrained NN filter.

14. The method of claim 11 further comprising: receiving, in or along a bitstream, at least one QP of the one or more QPs from an encoder.

15. The method of claim 11, wherein a decoder comprises a set of predetermined QPs, and wherein the method further comprises: receiving an indication, one or more QPs, and/or one or more QP updates, wherein the one or more QPs replace respective one or more predetermined QPs in the set of predetermined QPs, and wherein the one or more QP updates are used to update respective one or more predetermined QPs in the set of predetermined QPs based on an update rule that is predefined or based on the indication.

16. A method comprising:
signaling, in or along a bitstream, an update to a decoder;
signaling, in or along the bitstream, at least one quantization parameters (QP) of one or more QPs to the decoder; and
wherein the one or more QPs are used to quantize an updated neural network (NN) filter, and wherein the updated NN filter is based at least on a base or pretrained NN filter and on the update.

17. The method of claim 16, wherein at least another one QP of the one or more QPs is predetermined in an offline phase to generate at least one predetermined QP, and wherein the at least one predetermined QP is available at the decoder.

18. The method of claim 17, wherein the at least one predetermined QP is same or substantially same as a QP used to quantize the base or the pretrained NN filter.

19. The method of claim 16 further comprising: signaling, in or along the bitstream, at least one QP of the one or more QPs to the decoder.

20. The method of claim 16 further comprising: signaling an indication, one or more QPs, and/or one or more QP updates associated to respective one or more predetermined QPs comprised in a decoder, wherein the one or more QPs replace the respective one or more predetermined QPs, and wherein the one or more QP updates are intended to be used to update the respective one or more predetermined QPs based on an update rule that is predefined or based on the indication.
